(19) United States
(12) Patent Application Publication
(10) Pub. No.: US 2014/0372115 A1
(43) Pub. Date: Dec. 18, 2014

(54) Self-Directed Machine-Generated Transcripts

(71) Applicants: Michael J. LeBeau, Palo Alto, CA (US); John Nicholas Jitkoff, Palo Alto, CA (US)

(72) Inventors: Michael J. LeBeau, Palo Alto, CA (US); John Nicholas Jitkoff, Palo Alto, CA (US)

(73) Assignee: GOOGLE, INC., Mountain View, CA (US)

(21) Appl. No.: 13/250,744

(22) Filed: Sep. 30, 2011

Related U.S. Application Data
(63) Continuation of application No. 13/204,569, filed on Aug. 5, 2011.
(60) Provisional application No. 61/371,593, filed on Aug. 6, 2010.

(51) Int. Cl. G10L 15/26

(52) U.S. Cl. 704/235; 704/E15.043

(57) ABSTRACT

In one aspect, this application describes a computer-readable storage medium storing instructions that, when executed by one or more processing devices, cause the one or more processing devices to perform operations that include receiving, from a user of a computing device, a spoken input that includes a note and an activation phrase that indicates an intent to record the note. The operations also include determining a target address based at least in part on an identifier associated with a registered user of the computing device, wherein the target address is determined without receiving, from the user, an input indicating the target address when the spoken input is received. The operations also include defining a communication that includes a machine-generated transcript of the note, and sending the communication to the target address.

### CROSS-REFERENCE TO RELATED APPLICATION

This application is a continuation of U.S. application Ser. No. 13/204,563, filed on Aug. 5, 2011, entitled “Self-Directed Machine-Generated Transcripts,” which claims the benefit under 35 U.S.C. §119(e) of U.S. Provisional Application No. 61/371,593, filed Aug. 6, 2010. The entire contents of which are hereby incorporated by reference.

### BACKGROUND

Various software applications convert spoken input into machine-generated text. Some of the most well-known speech-to-text conversion programs include, for example, Dragon Naturally Speaking and IBM ViaVoice. In general, these programs allow a computer user to speak into a microphone and have their spoken words automatically turned into text. The text is generally placed on a canvas at the location of a cursor, such as onto the page of a document in a word processing application. This method of text input can save time for a user who is not able to type as fast as he or she can talk.

Some speech-to-text systems may also process spoken commands in addition to transcribing spoken text. For example, a user can speak the name of a label on a menu in order to select the menu, and may then speak the name of selections on the menu in order to choose the selections. Such an input method can, in some cases, enable hands-free operation of a computer.

### SUMMARY

This document describes systems and techniques for automatically creating notes for a user who speaks the notes into a computing device such as a mobile smartphone. In general, a user of a computing device can invoke voice input on the device and then speak “note to self” or another appropriate opening phrase followed by the text of the note. The computing device, either alone or in combination with one or more remote server systems, may use the opening phrase to determine the user's intent, and may then perform speech-to-text conversion on the note so as to create a transcript of the note. In some cases, the input from the user may not include information to identify a recipient of the text of the note, such as an electronic mail address of the recipient, the name of the recipient, or other similar information. In such cases, the device may determine parameters for presenting the text of the note based on the context of the input. For example, the device may determine that the text of the note should be delivered to or saved for the user who is currently logged in to the device. In such an example, the device may automatically form an email message that includes the transcript of the note in the body of the message, and may address the email message to an email address associated with the current user of the device, which may be stored in the current user's profile information. The device may also optionally attach an audio file that may include all or part of the spoken input from the user (e.g., the opening phrase may be removed so that the audio file includes only the audio for the note itself).

The systems and techniques may also, or alternatively, provide the text of the note to a note-managing application, such as Microsoft OneNote. For example, the device may have previously associated a data file for such an application with the currently-registered (e.g., logged on) user of the device, and may provide the data in an appropriate format (e.g., by utilizing a published application programming interface, or “API”) to the note-managing application. The text of the note may be appended to other notes that the user has previously input, such as by placing them on a single canvas in reverse chronological order so that the most recent note is displayed at the top. A user may also configure the application to have multiple canvases for notes, where each canvas relates to a particular topic. For example, a user may label one canvas as “personal,” another as “wedding ideas,” another as “Project A,” and the like, and can speak the name of the relevant label when providing an input so that the text of the note is placed on the appropriate canvas.

In one aspect, this application describes a computer-readable storage medium storing instructions that, when executed by one or more processing devices, cause the one or more processing devices to perform operations that include receiving, from a user of a computing device, a spoken input that includes a note and an activation phrase that indicates an intent to record the note. The operations also include determining a target address based at least in part on an identifier associated with a registered user of the computing device, wherein the target address is determined without receiving, from the user, an input indicating the target address when the spoken input is received. The operations also include defining a communication that includes a machine-generated transcript of the note, and sending the communication to the target address.

In another aspect, this application describes a computer-implemented system that includes a computing device having a microphone to receive spoken user input and to transmit the spoken user input for processing. The system also includes a speech-to-text converter module adapted to define a textual representation of the spoken user input. The system also includes an analyzer module adapted to identify an activation phrase included in the spoken user input, and initiate an automatic messaging process based at least in part on identification of the activation phrase, wherein the activation phrase indicates an intent to record at least a portion of the spoken user input. The system also includes a messaging module adapted to define a communication that includes at least a portion of the textual representation, associate the communication with an application, and store the communication in a memory associated with the application. In the system, identifying the activation phrase, defining the communication, associating the communication, and storing the communication are performed without user intervention.

In another aspect, this application describes a computer-implemented system that includes a speech-to-text converter module adapted to define a textual representation of the spoken user input. The system also includes an analyzer module adapted to identify an activation phrase included in the spoken user input, and initiate an automatic messaging process based at least in part on identification of the activation phrase, wherein the activation phrase indicates an intent to record at least a portion of the spoken user input. The system also includes means for causing, automatically and without user intervention, a communication to be defined and sent to a registered user associated with the computing device, the communication including at least a portion of the textual representation of the spoken user input.

Particular embodiments can be implemented, in certain instances, to realize one or more of the following advantages. In some examples, a user of a mobile computing device may form inspired ideas from time to time, but may lack an easy mechanism for remembering or recording such ideas. An idea may occur to the user at a time the user does not have a writing instrument available, such as when the user awakes in the middle of the night, or when the user is unable to use his or her hands to record the idea on a physical medium, such as paper. The techniques described herein may allow a user to speak the contents of an idea or a note and have his or her spoken words converted into text for storage at and/or transmission to one or more user accounts (e.g., e-mail accounts) or applications (e.g., note-taking applications) associated with the user. In this manner, a user may be able to conveniently capture ideas before forgetting them.

The details of one or more embodiments are set forth in the accompanying drawings and the description below. Other features, objects, and advantages will be apparent from the description and drawings, and from the claims.

### DESCRIPTION OF DRAWINGS

FIG. 1 illustrates a conceptual diagram of a mobile computing device processing a self-directed user-spoken note.

FIG. 2 is a block diagram of a system that provides delivery of personalized spoken notes from a mobile computing device.

FIG. 3 is a flow chart of a process for processing spoken notes.

FIG. 4 is a swim lane diagram of a process for making personal spoken notes available through a messaging system.

FIG. 5 is a conceptual diagram of a system that may be used to implement the systems and methods described in this document.

FIG. 6 is a block diagram of example computing devices that may be used to implement the systems and methods described in this document, as either a client or as a server or plurality of servers.

Like reference symbols in the various drawings indicate like elements.

### DETAILED DESCRIPTION

This document generally describes techniques for generating and delivering personal messages for users of computing devices, such as smartphones and other mobile computing devices. In general, a user of a computing device may speak a note within proximity of the device, the spoken content including a phrase that indicates the user's intention that the text of the note be saved for, associated with, or delivered to an account or an application associated with the current user of the device. Such a phrase may be referred to herein as an activation phrase, an opening phrase, or a carrier phrase.

In some implementations, the user may speak a carrier phrase (e.g., “note to self” or another appropriate phrase) before speaking the content of the note. The device may receive the carrier phrase and the spoken note via a microphone or other audio input device and store it in a memory. The device may also convert the note to text, or may send the note to a separate device, such as a processing server, to convert the audio into text. The device may additionally determine or identify an account, electronic mail address, or other appropriate identifier associated with the user of the device (e.g., a user account currently using or logged into the device and/or an operating system executing thereon), and may communicate the text of the note to an appropriate destination (e.g., by automatically generating and sending an electronic mail message to an account associated with the user without the user having to take any additional action, or by automatically storing the text of the note in a memory that is associated with a note-taking application associated with the user). In some cases, the user may provide input to the device (e.g., spoken input, input to confirm that the note should be sent (e.g., after speaking the note, but before the note is communicated).

The note may be output in a variety of manners. In one example, an audio file of the user speaking the note may be provided to a speech-to-text translation system or service so that a transcript of the note may be prepared as a textual representation of what the user said. The transcript may then be sent to an account for the user, such as an electronic mail account, based in part on an electronic mail address for a currently-registered user of the device. In some implementations, the transcript may also be sent to a note-managing application that may store the text of the note at a memory, along with other notes that the user has input into the device. The audio file of the user speaking the note may also be saved at a memory and may be associated with (e.g., attached to) a message (such as an electronic mail message), and/or a reference (e.g., a hypertext or other link) may be defined that includes a reference to a storage location of the audio file, thereby allowing a user who later reviews the text of the note to listen to the spoken words. The audio file may then be reviewed by the user, e.g., in cases where the transcript is unclear, where the transcript may have included errors in translation, or where the user wants to hear the tone of the spoken message.

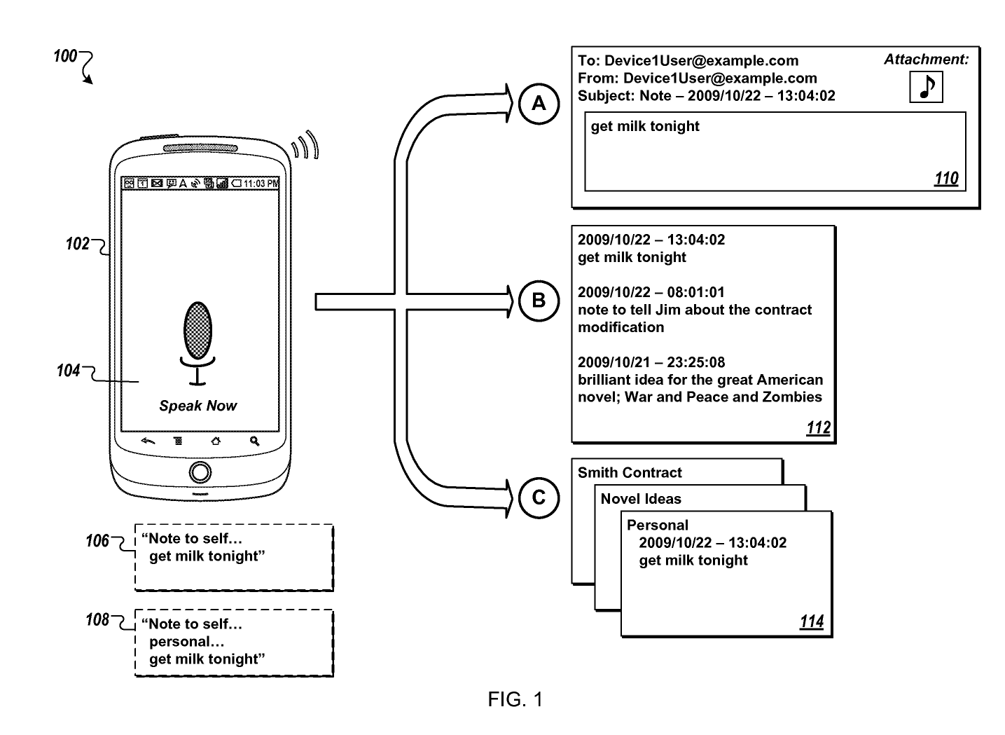

FIG. 1 illustrates a conceptual diagram of a mobile computing device 102 processing a self-directed user-spoken note. The device 102 in the example may take a variety of forms, and is shown for illustrative purposes as a smartphone with a touch screen display 104, on which directions and other feedback may be provided to a user of the device 102. In some embodiments, the device 102 may be a personal digital assistant (PDA), a laptop computer, a tablet, or the like. The device 102 may be equipped with a microphone and associated software for capturing spoken input from a user of the device 102, and for providing the input for appropriate processing, such as speech-to-text translation. The processing may occur entirely on the device 102, on a server system that is remote from the device 102 and operatively coupled thereto, or by a combination of both.

As shown in FIG. 1, the display 104 of the device 102 shows a graphic for a microphone and instructions for the user to “speak now,” indicating that the device is in an appropriate mode for receiving spoken user input, as opposed to typed user input or other types of input. As such, the user may speak into the device and may include commands and other statements that may be used in the operation of the device 102. In this example, two statements 106, 108 are shown, and represent two different forms of personal notes that the user may provide to the device 102.

A first statement 106 is “note to self . . . get milk tonight,” and may be a note that the user provides to the device 102 sometime during the workday when the user remembers that he or she needs to purchase milk for the family before going home for the day. The device 102 may enable the user to input the note verbally, such as by pressing a microphone button on the device 102 and then speaking the note, or simply by speaking the note. In the latter situation, the device 102 may be in a “listening” mode, in which it is detecting/recording spoken words and determining whether any predefined spoken carrier phrases are detected. If so, the device 102 may execute one or more actions and/or operations associated with a particular detected carrier phrase. In this example, the carrier phrase is “note to self.”

A second statement 108 is similar to the first statement but includes a carrier sub-phrase, such as “personal” in this example. Under the syntax of the example system 100, such a sub-phrase may be used to indicate what actions are to be executed/performed by the device 102 with respect to the self-directed note that the user has just spoken. In this example, the sub-phrase indicates a virtual note or similar categorization that identifies a category of the note. For example, note-managing applications such as Microsoft OneNote allow a user to define multiple different tabs within a notebook and to label those tabs. In some cases, a user may define a tab for each of a number of projects that he or she is working on, and/or for other categories of information that the user may define to store and manage notes (e.g., personal events, hobbies, or other such categories of information). The sub-phrase spoken by the user may be intended to match one of the above-described tabs or labels for a portion of a notebook in a notebook-managing application. As discussed here, a particular tab within a notebook may be displayed as a particular sheet of paper within the note-managing application, and may thus be referred to as a canvas on which the text for a note and other metadata associated with the note may be stored.

As shown in FIG. 1, the arrows labeled A, B, and C, indicate three example options of actions that may be taken in response to a user input of a self-directed note. Each of these actions may be performed independent of the other actions and may be selected based on user account settings provided in the device 102. The actions may also or alternatively be selected based on carrier sub-phrases, phrases employed by the user when entering the note, or other similar factors. Each of the actions may also be performed in tandem and automatically, so that user entry of a note may cause the text of that note to be stored and/or distributed to different storage locations and/or in different manners.

Arrow A illustrates that an electronic mail message may be generated in response to a spoken user input. In some implementations, the user may not provide an electronic mail address or other address information for the electronic mail message, such as a name or an alias associated with an intended recipient of the message. Rather, the electronic mail address may be determined without such input from the user. For example, the electronic mail address of the intended recipient may be based on information in a user profile for a user who is currently logged into the device 102. In this example, the message may be sent to and received from the same electronic mail address—namely, the electronic mail address associated with the current user of the device.

A transcript of the body of the note, which is the portion spoken by the user excluding any identified carrier phrases, may be included in the electronic mail message 110 body field. In addition, the message 110 may indicate that it includes an attachment of an audio file that represents audibly the user input that was captured by the device 102. The attachment may include all of the spoken input from the user, or may include only the body of the note, in which case the portion of the audio file that includes any carrier phrases or sub-phrases may be removed from the audio file. In some implementations, such removal may occur by coordinating the speech-to-text translation with timestamps in the audio file, so that after certain terms in the text version of the note are determined to be carrier phrases, the location in the audio file of those terms can be identified, and that portion of the audio file may be removed before attaching the audio file to the message 110.

Certain metadata relating to the message 110 may also be provided with the electronic mail message 110. In the example shown, the subject line of the electronic mail message 110 has been annotated automatically by the system 100 to indicate that the message includes a note, and to also indicate the date and time at which the note was provided or transcribed by the system 100. Such generation of the subject line may allow a user of the device 102 to more easily locate his or her notes, such as by sorting the electronic mail inbox by the subject line of the messages, or by searching for the term “note” in this example.

Arrow B indicates an example of a canvas 112 (e.g., within a note-managing application), on which various spoken notes that have been input to the device 102 and stored over time. In this example, canvas 112 displays three different notes that are generally arranged in reverse chronological order. In such implementations, the system 100 may, when it creates a new note, add the new note to the top of canvas 112 along with relevant metadata that describes the note. The metadata may include, for example, the date and time at which the note was input, and/or other appropriate metadata that may be associated with the note. In this manner, the canvas 112 may effectively provide a journal into which a user may conveniently input his or her thoughts and/or ideas. The canvas may also be arranged or sorted in other appropriate manners, such as in chronological order, grouped by time of day, etc.

According to the techniques described herein, the above-described actions may occur without the user typing or otherwise physically contacting device 102, except to place the device 102 into a spoken input mode in some cases. In some implementations, the user may activate a spoken input mode on the device 102 using verbal commands. For example, the device may execute a service that detects a carrier phrase that is input to the device 102, and acts on the carrier phrase when it is detected. Where such a service is used, the device may initially hash all spoken input to maintain privacy for conversations that are occurring within the detection area of the device 102, and may compare such hashed data to hashed versions of the various carrier phrases to which the device 102 is configured to respond. In such a manner, a system operating a speech recognition service may not be configured to record any of the words that are being spoken in the vicinity of the device 102 unless and until a specific carrier phrase is detected. The device may then provide a prompt to the user indicating that the service has detected the particular carrier phrase, and request that the user respond audibly, such as by speaking the text of a note, or by canceling the recording using another predetermined command.

In some implementations, the system 100 may generate message 110 and send it to the user associated with device 102, and may also add information for the transcript of the spoken note to canvas 112. In such a manner, the user may receive the electronic mail message in a frequently-used application (e.g., an electronic mail application), and the text of the note may also be stored and maintained in a separate storage location, which may provide a log and/or listing of the user's notes (e.g., for archival purposes). Although not shown, a reference such as a hyperlink or other appropriate item may be displayed in canvas 112. The reference may allow the user to access an audio file that corresponds to the note.

Arrow C shows an example of processing a spoken input, e.g., statement 108, that includes a carrier sub-phrase. As noted above, statement 108 in this example includes a carrier sub-phrase that indicates a particular tab or canvas of a note-managing application to which a note is to be applied. In this example, the user has three different canvases, labeled “Smith Contract,” “Novel Ideas,” and “Personal.” Because the user spoke the carrier sub-phrase “personal” during input of the note, the text of the note may automatically be added to the “Personal” canvas, which stores and arranges personal notes of the user. In such an example, the label “Personal” may also be added to the subject line of the electronic mail message 110, or in another appropriate area, such as in a predetermined location of the body of the electronic mail message 110.

Although three particular output examples are shown here, the automatic sending of the spoken note can occur by various other manners as well. For example, a note may be added to a row of a particular spreadsheet, or may be sent to a particular email account for a user. Also, the text of a note may be analyzed to determine topics or other meanings in the note, and it may be further processed (e.g., by the device or by a remote server) using such analysis. For example, rather than a user speaking a carrier sub-phrase as described above, the note may be categorized based on an analysis of the content of the note.

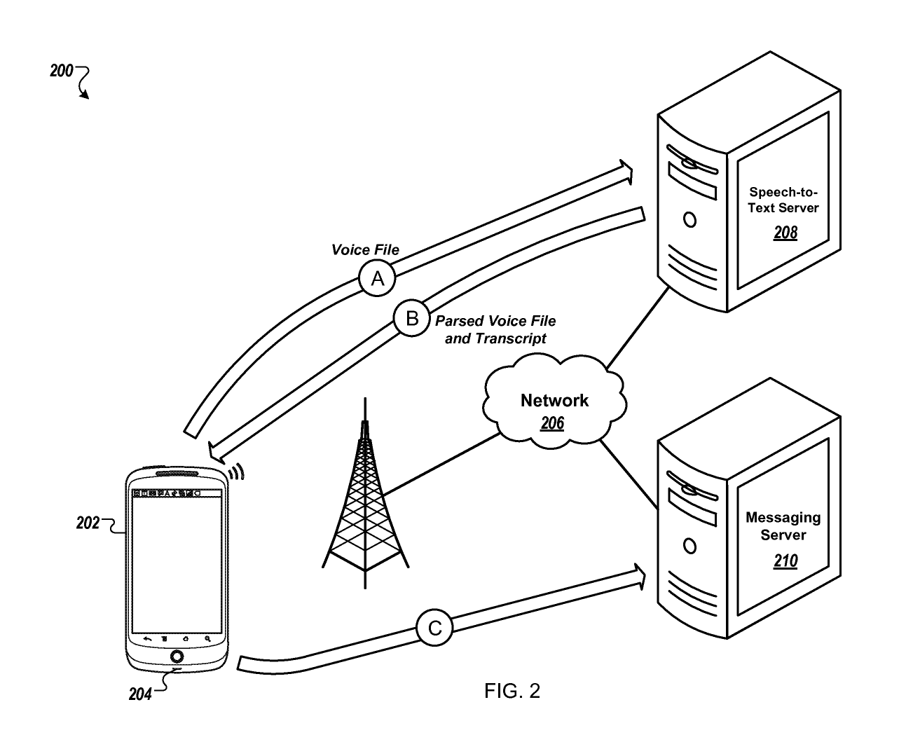

FIG. 2 is a block diagram of a system 200 that provides delivery of personalized spoken notes from a mobile computing device. In general, the system 200 shows a mobile device 202 that may communicate over a network 206 with various server systems 208 and 210, to allow a user of the device 202 to have personal notes delivered automatically to the user's accounts or applications.

In the system 200, the mobile device 202 may include a microphone 204 or other appropriate input mechanism through which a user can provide spoken input to control the device 202 and to input information that may be transcribed by or for the device 202. Separately, a speech-to-text server system 208 may operate in a remote location from device 202, and may be part of a larger system or group of services provided by an organization that offers a variety of Internet-connected services. For example, the organization may also provide search engines services, mapping services, document and spreadsheet services, and other similar common services. The speech-to-text server 208 may employ various appropriate mechanisms for converting spoken input from users received over the network 206 into textual representations of what the users have spoken.

The speech-to-text server system 208 may be operated by an organization that developed an operating system for the mobile device 202. In some implementations, the speech-to-text server system 208 and the mobile device 202 may communicate using an application programming interface (“API”) by which data is submitted in various forms from the mobile device 202 to the speech-to-text server system 208, and responsive data is provided from the server system 208 back to the mobile device 202.

In certain circumstances, the speech-to-text server system 208 may be capable of separating commands that are provided via spoken input from other data provided by the spoken input, such as text on which the commands are to be executed. The commands may be referred to as carrier phrases, in that their introduction by the user is intended to invoke a particular action by the system 200. In general, a carrier phrase may occur at the beginning of a particular spoken input, and may take the form of one to several words.

The server system 208 may maintain a set of predefined carrier phrases, which may include common carrier phrases that are available to all users of system 200 in addition to carrier phrases that may be specific to a user of device 202. Relevant to the examples here, the server system 208 may be responsive to a carrier phrase, such as “note to self,” that may cause subsequent information that is spoken by the user to be stored in a memory or distributed to a storage location that is easily available to the user. According to the techniques described herein, such actions may occur automatically, without the user specifying the storage mechanism or location for the note. The particular storage location may be available only to the particular user, or to others with credentials for the user, so that the text of the note remains private to the user. For example, the information may be sent in an electronic mail message to the user of the device 202, and also stored in memory in an application data storage area that is accessible only to the user of the device 202, or someone else who is logged in as the user. In other implementations, the text of the note may be stored to a publicly-accessible location, such as a bulletin board, depending on the intent of the user. As described in the examples above, the intent of the user may be determined based on an indication provided by the user, such as by the user speaking a carrier sub-phrase that specifies a particular category for the note (e.g., “Public” versus “Private”), or may be determined based on an analysis of the content of the note.

A messaging server 210 may be operated by the same organization that operates the speech-to-text server 208 or by a different organization. In some implementations, the messaging server 210 may be an ordinary electronic mail messaging or text messaging system, or may be another appropriate messaging system. Although not shown, a note-managing application server may also be included as part of system 200 to save text and audio for notes that are provided by a user of device 202.

The messaging server 210 may take a standard form when used with the techniques here, as the device 202 may be responsible for addressing and generating messages that are automatically distributed to a user of the device 202. Alternatively, the messaging server 210 may be supplemented in various ways to support the techniques described herein. For example, the messaging server 210 may be configured to process the messages (e.g., by preparing or supplementing the messages), such that portions of the processing responsibilities may be performed by the messaging server 210, in addition to or alternatively to the device 202 performing such processing.

In FIG. 2, the arrows are intended to illustrate exemplary flows of information that may be utilized during a process for automatically providing a transcript of a spoken note received by device 202 to an account or application for the user who is currently using the device. As shown by Arrow A, the device 202 may send to the speech-to-text server system 208 a voice file that contains the detected and recorded spoken note. The voice file may be recorded in response to the user activating a “listening mode” on the device 202, and speaking within proximity of the device in a manner that is detectable by the audio input mechanism of the device. At this point, it may be unknown to the system what form the voice input takes, and what actions the user intends the system 200 to perform in response to the voice input. In certain examples, the transmission of the file to the server system 208 may occur only after the device 202 has recognized a carrier phrase from the user, and then recorded subsequent input for the purpose of providing the subsequent input to the server system 208.

Arrow B shows the speech-to-text server system 208 returning a parsed voice file and transcript to device 202. The actions performed by the server system to create the transcript may include converting the received voice file into text, and returning the text to the device 202 so that the device 202 can process and analyze the text. The device 202 may then, either on its own or under control of commands received from the speech-to-text server system 208, cause the text from the transcript to be added to a message, and optionally also cause a copy of the voice file to be attached to the message. The device 202 may also cause the message to be addressed automatically to a currently-registered user of the device 202 who is logged into the device 202. An electronic mail address for such a user may be obtained by consulting a user profile for the device 202, or by querying a message server system 210 for an electronic mail address of the user who is logged into messaging server system 210 using device 202. The electronic mail address may alternatively be obtained by opening a new message and identifying the user that the messaging application on device 202 has listed as the sending user, and copying the electronic mail address from the “from” field to the “to” field. In some implementations, certain of the actions described above may be performed, in whole or in part, by other parts of the system.

Arrow C then shows the sending of the message, which may occur automatically by device 202 and through messaging server system 210. In certain examples, the message may be sent using known mechanisms, such as by the device 202 invoking a send function in a messaging application. Because the message may already have been addressed to the appropriate user, it may be sent using standard messaging mechanisms.

In this manner, the system 200 may provide for the convenient and automated distribution of textual transcripts of spoken messages that users record for themselves. The process may be automatic, in that the user need only speak the message, and need not provide an electronic mail address or user handle for a recipient of the message. Instead, the system 200 may automatically send and/or address the message to the current user of the device 202.

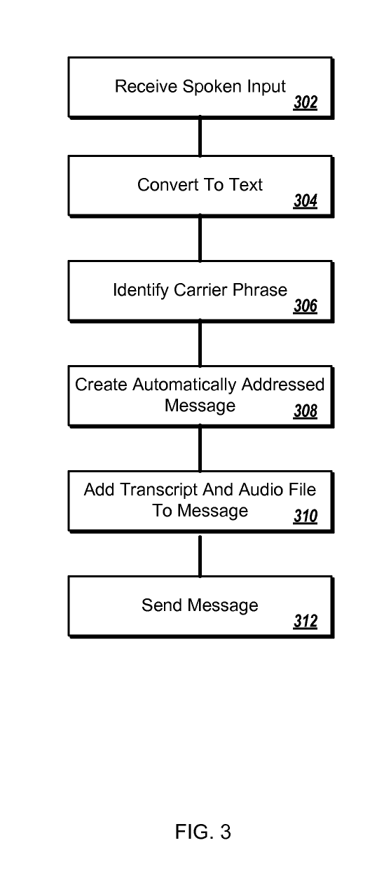

FIG. 3 is a flow chart of a process for processing spoken notes. In general, the process involves receiving spoken user inputs into a computing device, converting the inputs to textual form, and providing at least a part of the converted message to an account or application that is accessible to a user of a particular device that receives the message.

The process begins at box 302, where a spoken input is received by a computing device. The input may be received from a user who is using a portable computing device and may take the form of one or more sentences of information that the user would like to have saved and archived on his or her behalf so that it can be accessed by the user at a later time.

At box 304, the spoken input is converted to text. Such conversion may be performed using a variety of known mechanisms, including using systems that have previously been trained by the particular user, and those that have not. The converted text may include a note that the user wants to save, and in certain examples may include additional information, such as a carrier phrase that begins the spoken input. The carrier phrase may be a phrase known to the user to initiate particular actions by a system, such as to send a personal note to a note-managing application or an electronic mail account. The spoken input may also include a carrier sub-phrase, which may further define the particular actions that the user wishes the system to perform, such as to identify a particular label or category that the system should apply to the note.

At box 306, a carrier phrase is identified in the converted text. Alternatively, the carrier phrase may be identified before the text is created, such as by matching an audio signature of the carrier phrase to a portion of the received file that includes the spoken input, or by identifying the carrier phrase in real-time (or near real-time) before the audio file is created, and using the identification of the carrier phrase to trigger the recording of subsequent input and further handling of the process.

Although a particular carrier phrase for providing self-directed messages has been described in this document, the process may utilize a variety of different carrier phrases and may act accordingly based on what carrier phrase is identified. For example, the carrier phrase “play” may be interpreted by the device to cause performance of a particular action using a media player, such as to play a song whose title matches the words that a user speaks after saying the carrier phrase “play.” The process may discriminate between the various stored carrier phrases and may match subsequent actions to the carrier phrase that has been identified. In the self-directed note-taking example, subsequent steps that involve sending a message to a user of a device may be performed when the carrier phrase that is identified by the system matches a predetermined carrier phrase (e.g., “note to self”) for performing such actions. If no carrier phrase is identified, the device and process may perform a default action with the input text, such as by submitting the text to a search engine and delivering results provided by the search engine. In certain examples, the default action may be to store or distribute a message directed to an account or application for the user. In such example, a carrier phrase may not be used to trigger the actions discussed in the following steps of the process.

At box 308, the process creates an automatically-addressed message, where the recipient address for the message may be identified by a context of the device on which the spoken input was received. For example, an address of a current user of the device may be identified in various manners, such as in the manners discussed above. In addition to being addressed to a user of the device, the message may also be automatically formatted in various other ways. For example, a copy of all or part of a file that represents the originally-received spoken input may be attached to the message, and the converted text representation of the message may also or alternatively be provided in the body of the message. As discussed above, other metadata relating to the message may also be included in the message, including a time and date at which the message was created, a location of the user when the message was created (e.g., as determined using GPS functionality on a computing device), metadata related to other carrier phrases or sub-phrases that a user may have spoken (e.g., a categorization of the note made by the user), keywords for the note that may have been determined by a server system that analyzed the text of the note to identify topics with which the note may be associated, and other relevant information that may be helpful, for example, for reviewing, locating, and/or classifying the note.

At box 310, the transcript and audio file are added to the message as discussed above, and at box 312 the message is sent. The sending of the message may occur in a conventional manner where the message is an electronic mail message, such that the message appears in an inbox of the user of the device, with the transcript text in the body of the message, and the audio file attached to the message. Other actions may also or alternatively be performed, such as adding a copy of the transcript text and metadata to a part of a note-taking application, such as a particular tab within a note-taking application, where the tab may be selected based on a carrier phrase spoken by the user when providing the spoken input.

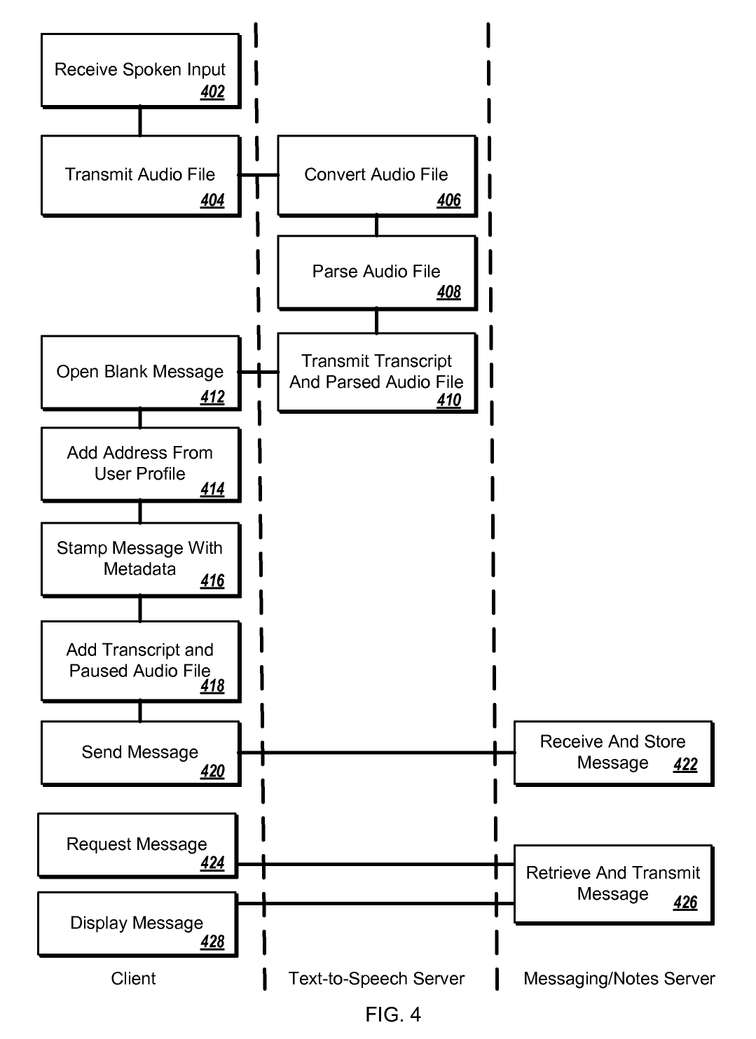

FIG. 4 is a swim lane diagram of a process for making personal spoken notes available through a messaging system. The process is similar to the process discussed with respect to FIG. 3, but particular actions are shown in this example to indicate actions that may occur on each of the particular components in a system. In other examples, the actions may be distributed amongst the various system components in a different manner, or additional components may be included in the system, or the functionality of certain of the components may be merged with or otherwise processed using other system components than are shown.

The process begins at box 402, where spoken input is received from a user. As discussed above, the spoken input may include one or more carrier phrases along with the text of a note that a user wishes to save for later review. At box 404, the client device that the user is employing may transmit an audio file that includes the spoken input to a text-to-speech server system. The server system may then convert the audio file, at box 406, e.g., into a textual representation of the audio file. At box 408, the audio file may be parsed, such as to identify carrier phrases that may be included in the file, and to distinguish those carrier phrases from the actual note that was input by the user. At box 410, the server system may transmit the transcript of the note and the parsed audio file back to the client device. In some implementations, the server system may remove the one or more carrier phrases from the audio file and return the modified audio file back to the client.

At box 412, after receiving the information back from the server system, the client device may open a blank electronic mail message or other form of message. At box 414, the client device may address the message to the user (e.g., based on information stored in the user profile of the device). The message may automatically be addressed to whoever the user of the device happens to be at the moment, without the person who entered the spoken input identifying a particular recipient of the message. The address may also be obtained using other mechanisms and/or from other locations, such as from a messaging application that is executing on the client device.

At box 416, the process may add metadata to be included with the message. The metadata may be added in various locations, including in a subject line of an electronic mail message and a body of the message. The metadata may take various forms such as those described above, and a user may be provided with an opportunity to identify the categories of metadata that will be added to messages using the processes described herein. For example, the user may want to only have a time and date stamped on their notes, with no other additional information. In addition, the user may be allowed to specify a title that will be used for all of his or her notes so that the text of the notes can easily be found in the user's inbox of an electronic mail application. For example some users may simply want their notes entitled “Notes.” Other users may want the notes titled with their personal name, so that all of their notes can be easily distinguished from other electronic mails that they may receive from other users.

At box 418, the process may add the transcript and the parsed audio file to the message in a familiar manner, though automatically instead of manually. At box 420, the process may automatically send the message which may simply involve causing a send command to be issued for the message.

At some later point in time, a user may want to see one or more of the notes that have been stored using the process described herein. For example, the actions described in boxes 402 through 422 may have been repeated by a user a number of times over the course of hours, days, or weeks, and the user may have accumulated one or more personal notes during that time span. At box 424, the user may request one or more of his or her personal notes. Such a request may take the form of the user searching the inbox of an electronic mail application for a particular term of metadata that has been added by the automatic process to all of the user's notes (e.g., “Bob note”). The user may then browse through the individual notes looking for the text of the note that is of interest. Upon the user request, at box 426, a messaging server may provide all matching notes back to the user at the client device, and at box 428, the client device may display the particular message or messages requested by the user.

Alternatively, the user may launch a note-managing application that may be accessible from the user's computing device, and may navigate to a page or tab in the application where text of the user's various notes have been saved. For example, each time a user records a note in any of the manners described above, the text for that note and any relevant metadata may be appended to the end of a canvas in the note-managing application so as to create a running document. In some implementations, the document may be similar to a blog for the user, and may be sorted in chronological or reverse chronological order, or in any other appropriate manner. The user may then edit, copy, or otherwise manipulate the text for any of the notes they have created. For example, if the user is writing and researching a nonfiction book, he or she may cut and paste various quotes that have been spoken into a portable computing device over the course of the user's research, and may place the quotes into the book as it is drafted and edited. Alternatively, the user may have saved a spoken note during certain interactions with a particular business partner. The user may return to a list of such notes after-the-fact to help remember the sort of agreement that was made with the business partner or to help understand what sorts of actions that need to be performed in order to follow through on the agreement.

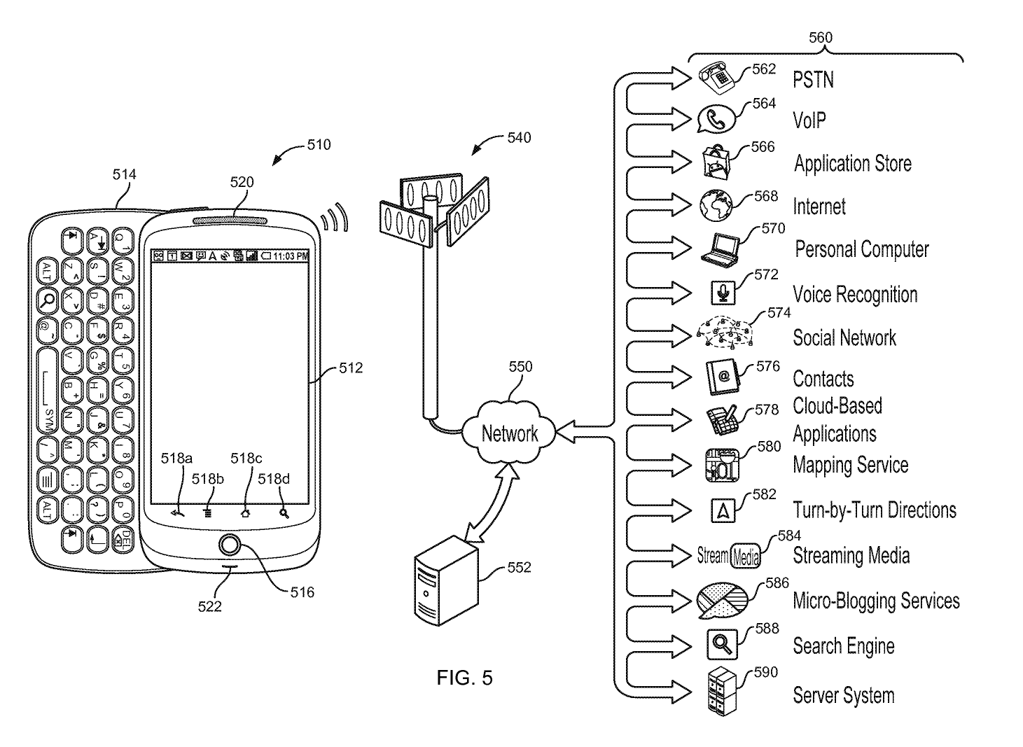

FIG. 5 is a conceptual diagram of a system that may be used to implement the systems and methods described in this document. Mobile computing device 510 can wirelessly communicate with base station 540, which can provide the mobile computing device wireless access to numerous services 560 through a network 550.

In this illustration, the mobile computing device 510 is depicted as a handheld mobile telephone (e.g., a smartphone or an application telephone) that includes a touchscreen display device 512 for presenting content to a user of the mobile computing device 510. The mobile computing device 510 includes various input devices (e.g., keyboard 514 and touchscreen display device 512) for receiving user-input that influences the operation of the mobile computing device 510. In further implementations, the mobile computing device 510 may, for example, be a laptop computer, a tablet computer, a personal digital assistant, an embedded system (e.g., a car navigation system), a desktop computer, or a computerized workstation.

The mobile computing device 510 may include various visual, auditory, and tactile user-output mechanisms. An example visual output mechanism is display device 512, which can visually display video, graphics, images, and text that combine to provide a visible user interface. For example, the display device 512 may be a 3.7 inch AMOLED screen. Other visual output mechanisms may include LED status lights (e.g., a light that blinks when a voicemail has been received).

An example tactile output mechanism is a small electric motor that is connected to an unbalanced weight to provide a vibrating alert (e.g., to vibrate in order to alert a user of an incoming telephone call or confirm user contact with the touchscreen 512). Further, the mobile computing device 510 may include one or more speakers 520 that convert an electrical signal into sound, for example, music, an audible alert, or voice of an individual in a telephone call.

An example mechanism for receiving user-input includes keyboard 514, which may be a full qwerty keyboard or a traditional keypad that includes keys for the digits ‘0-9’, ‘*’, and ‘#.’ The keyboard 514 receives input when a user physically contacts or depresses a keyboard key. User manipulation of a trackball 516 or interaction with a trackpad enables the user to supply directional and rate of rotation information to the mobile computing device 510 (e.g., to manipulate a position of a cursor on the display device 512).

The mobile computing device 510 may be able to determine a position of physical contact with the touchscreen display device 512 (e.g., a position of contact by a finger or a stylus). Using the touchscreen 512, various “virtual” input mechanisms may be produced, where a user interacts with a graphical user interface element depicted on the touchscreen 512 by contacting the graphical user interface element. An example of a “virtual” input mechanism is a “software keyboard,” where a keyboard is displayed on the touchscreen and a user selects keys by pressing a region of the touchscreen 512 that corresponds to each key.

The mobile computing device 510 may include mechanical or touch sensitive buttons 518a-d. Additionally, the mobile computing device may include buttons for adjusting volume output by the one or more speakers 520, and a button for turning the mobile computing device on or off. A microphone 522 allows the mobile computing device 510 to convert audible sounds into an electrical signal that may be digitally encoded and stored in computer-readable memory, or transmitted to another computing device. The mobile computing device 510 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include the ANDROID mobile device platform; APPLE IPHONE/MAC OS X operating systems; MICROSOFT WINDOWS 7/WINDOWS MOBILE operating systems; SYMBIAN operating system; RIM BLACKBERRY operating system; PALM WEB operating system; a variety of UNIX-flavored operating systems; or a proprietary operating system for computerized devices. The operating system may provide a platform for the execution of application programs that facilitate interaction between the computing device and a user.

The mobile computing device 510 may present a graphical user interface with the touchscreen 512. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 504. User-selection of the button may invoke the pre-defined action.

In some examples, the operating system provides a “desktop” user interface that is displayed upon turning on the mobile computing device 510, activating the mobile computing device 510 from a sleep state, upon “unlocking” the mobile computing device 510, or upon receiving user-selection of the “home” button 518c. The desktop graphical interface may display several icons that, when selected with user-input, invoke corresponding application programs. An invoked application program may present a graphical interface that replaces the desktop graphical interface until the application program terminates or is hidden from view.

User-input may manipulate a sequence of mobile computing device 510 operations. For example, a single-action user input (e.g., a single tap of the touchscreen, swipe across the touchscreen, contact with a button, or combination of these at a same time) may invoke an operation that changes a display of the user interface. Without the user-input, the user interface may not have changed at a particular time. For example, a multi-touch user input with the touchscreen 512 may invoke a mapping application to “zoom-in” on a location, even though the mapping application may have by default zoomed-in after several seconds.

The desktop graphical interface can also display “widgets.” A widget is one or more graphical interface elements that are associated with an application program that has been executed, and that display on the desktop content controlled by the executing application program. Unlike an application program, which may not be invoked until a user selects a corresponding icon, a widget's application program may start with the mobile telephone. Further, a widget may not take focus of the full display. Instead, a widget may only “own” a small portion of the desktop, displaying content and receiving touchscreen user-input within the portion of the desktop.

The mobile computing device 510 may include one or more location-identification mechanisms. A location-identification mechanism may include a collection of hardware and software that provides the operating system and application programs an estimate of the mobile telephone's geographical position. A location-identification mechanism may employ satellite-based positioning techniques, base station transmitting antenna identification, multiple base station triangulation, internet access point IP location determinations, inferential identification of a user's position based on search engine queries, and user-supplied identification of location (e.g., by “checking in” to a location).

The mobile computing device 510 may include other application modules and hardware. A call handling unit may receive an indication of an incoming telephone call and provide a user capabilities to answer the incoming telephone call. A media player may allow a user to listen to music or play movies that are stored in local memory of the mobile computing device 510. The mobile telephone 510 may include a digital camera sensor, and corresponding image and video capture and editing software. An internet browser may enable the user to view content from a web page by typing in an addresses corresponding to the web page or selecting a link to the web page.

The mobile computing device 510 may include an antenna to wirelessly communicate information with the base station 540. The base station 540 may be one of many base stations in a collection of base stations (e.g., a mobile telephone cellular network) that enables the mobile computing device 510 to maintain communication with a network 550 as the mobile computing device is geographically moved. The computing device 510 may alternatively or additionally communicate with the network 550 through a Wi-Fi router or a wired connection (e.g., Ethernet, USB, or FIREWIRE). The computing device 510 may also wirelessly communicate with other computing devices using BLUETOOTH protocols, or may employ an ad-hoc wireless network.

A service provider that operates the network of base stations may connect the mobile computing device 510 to the network 550 to enable communication between the mobile computing device 510 and other computerized devices that provide services 560. Although the services 560 may be provided over different networks (e.g., the service provider's internal network, the Public Switched Telephone Network, and the Internet), network 550 is illustrated as a single network. The service provider may operate a server system 552 that routes information packets and voice data between the mobile computing device 510 and computing devices associated with the services 560.

The network 550 may connect the mobile computing device 510 to the Public Switched Telephone Network (PSTN) 562 in order to establish voice or fax communication between the mobile computing device 510 and another computing device. For example, the service provider server system 552 may receive an indication from the PSTN 562 of an incoming call for the mobile computing device 510. Conversely, the mobile computing device 510 may send a communication to the service provider server system 552 initiating a telephone call with a telephone number that is associated with a device accessible through the PSTN 562.

The network 550 may connect the mobile computing device 510 with a Voice over Internet Protocol (VoIP) service 564 that routes voice communications over an IP network, as opposed to the PSTN. For example, a user of the mobile computing device 510 may invoke a VoIP application and initiate a call using the program. The service provider server system 552 may forward voice data from the call to a VoIP service, which may route the call over the internet to a corresponding computing device, potentially using the PSTN for a final leg of the connection.

An application store 566 may provide a user of the mobile computing device 510 the ability to browse a list of remotely stored application programs that the user may download over the network 550 and install on the mobile computing device 510. The application store 566 may serve as a repository of applications developed by third-party application developers. An application program that is installed on the mobile computing device 510 may be able to communicate over the network 550 with server systems that are designated for the application program. For example, a VoIP application program may be downloaded from the Application Store 566, enabling the user to communicate with the VoIP service 564.

The mobile computing device 510 may access content on the internet 568 through network 550. For example, a user of the mobile computing device 510 may invoke a web browser application that requests data from remote computing devices that are accessible at designated universal resource locations. In various examples, some of the services 560 are accessible over the internet.

The mobile computing device may communicate with a personal computer 570. For example, the personal computer 570 may be the home computer for a user of the mobile computing device 510. Thus, the user may be able to stream media from his personal computer 570. The user may also view the file structure of his personal computer 570, and transmit selected documents between the computerized devices.

A voice recognition service 572 may receive voice communication data recorded with the mobile computing device's microphone 522, and translate the voice communication into corresponding textual data. In some examples, the translated text is provided to a search engine as a web query, and responsive search engine search results are transmitted to the mobile computing device 510.

The mobile computing device 510 may communicate with a social network 574. The social network may include numerous members, some of which have agreed to be related as acquaintances. Application programs on the mobile computing device 510 may access the social network 574 to retrieve information based on the acquaintances of the user of the mobile computing device. For example, an “address book” application program may retrieve telephone numbers for the user's acquaintances. In various examples, content may be delivered to the mobile computing device 510 based on social network distances from the user to other members. For example, advertisement and news article content may be selected for the user based on a level of interaction with such content by members that are “close” to the user (e.g., members that are “friends” or “friends of friends”).

The mobile computing device 510 may access a personal set of contacts 576 through network 550. Each contact may identify an individual and include information about that individual (e.g., a phone number, an email address, and a birthday). Because the set of contacts is hosted remotely to the mobile computing device 510, the user may access and maintain the contacts 576 across several devices as a common set of contacts.

The mobile computing device 510 may access cloud-based application programs 578. Cloud-computing provides application programs (e.g., a word processor or an email program) that are hosted remotely from the mobile computing device 510, and may be accessed by the device 510 using a web browser or a dedicated program. Example cloud-based application programs include GOOGLE DOCS word processor and spreadsheet service, GOOGLE GMAIL webmail service, and PICASA picture manager.

Mapping service 580 can provide the mobile computing device 510 with street maps, route planning information, and satellite images. An example mapping service is GOOGLE MAPS. The mapping service 580 may also receive queries and return location-specific results. For example, the mobile computing device 510 may send an estimated location of the mobile computing device and a user-entered query for “pizza places” to the mapping service 580. The mapping service 580 may return a street map with “markers” superimposed on the map that identify geographical locations of nearby “pizza places.”

Turn-by-turn service 582 may provide the mobile computing device 510 with turn-by-turn directions to a user-supplied destination. For example, the turn-by-turn service 582 may stream to device 510 a street-level view of an estimated location of the device, along with data for providing audio commands and superimposing arrows that direct a user of the device 510 to the destination.

Various forms of streaming media 584 may be requested by the mobile computing device 510. For example, computing device 510 may request a stream for a pre-recorded video file, a live television program, or a live radio program. Example services that provide streaming media include YOUTUBE and PANDORA.

A micro-blogging service 586 may receive from the mobile computing device 510 a user-input post that does not identify recipients of the post. The micro-blogging service 586 may disseminate the post to other members of the micro-blogging service 586 that agreed to subscribe to the user.

A search engine 588 may receive user-entered textual or verbal queries from the mobile computing device 510, determine a set of internet-accessible documents that are responsive to the query, and provide to the device 510 information to display a list of search results for the responsive documents. In examples where a verbal query is received, the voice recognition service 572 may translate the received audio into a textual query that is sent to the search engine.

These and other services may be implemented in a server system 590. A server system may be a combination of hardware and software that provides a service or a set of services. For example, a set of physically separate and networked computerized devices may operate together as a logical server system unit to handle the operations necessary to offer a service to hundreds of individual computing devices.

In various implementations, operations that are performed “in response” to another operation (e.g., a determination or an identification) are not performed if the prior operation is unsuccessful (e.g., if the determination was not performed). Features in this document that are described with conditional language may describe implementations that are optional. In some examples, “transmitting” from a first device to a second device includes the first device placing data into a network, but may not include the second device receiving the data. Conversely, “receiving” from a first device may include receiving the data from a network, but may not include the first device transmitting the data.

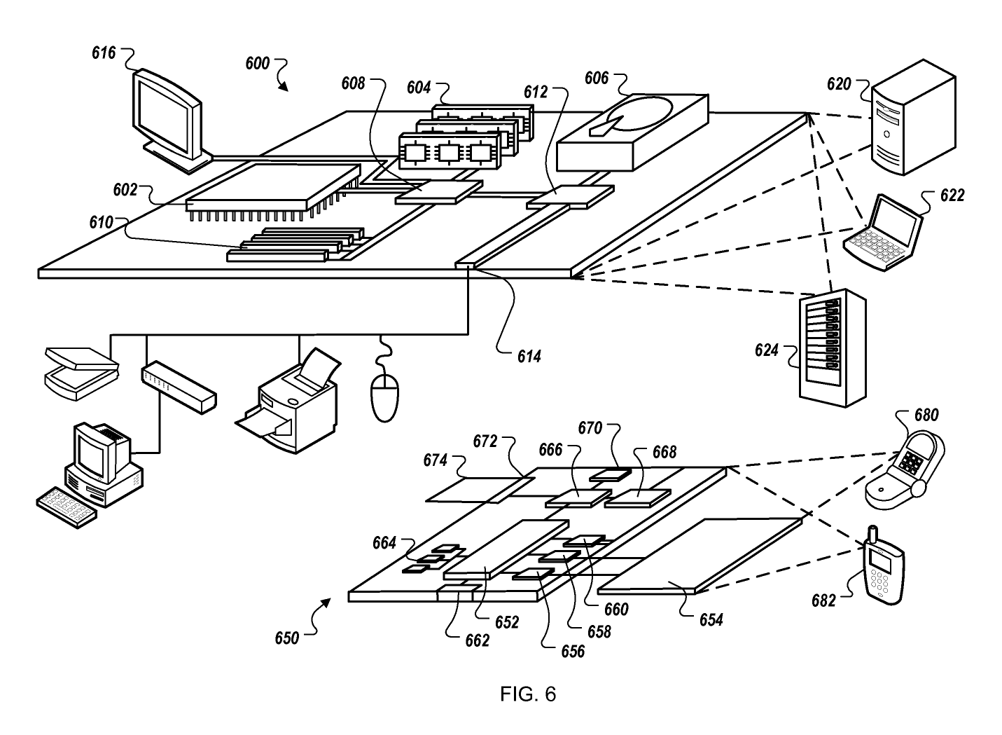

FIG. 6 is a block diagram of example computing devices 600, 650 that may be used to implement the systems and methods described in this document, as either a client or as a server or plurality of servers. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. Additionally computing device 600 or 650 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple busses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, or memory on processor 602.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various busses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provided in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, or memory on processor 652.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, Wi-Fi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files, etc.) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor.

To provide for interaction with a user, the systems and techniques described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described herein can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described herein), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A computer program product tangibly embodied in a non-transitory computer-readable storage device, the computer program product storing instructions that, when executed by one or more processing devices, cause the one or more processing devices to perform operations comprising:
receiving, from a user of a computing device, a spoken input that includes a note and an activation phrase that indicates an intent to record the note;
determining that the activation phrase has been received by analyzing the beginning of the spoken input to identify one or more words as the activation phrase;
in response to determining that the activation phrase has been received, automatically:
activating a recording mode and recording the note in the recording mode;
defining electronic mail message that is addressed to a target electronic mail address and that includes a machine-generated transcript of the note in a body of the electronic mail message, the target electronic mail address being determined without receiving, from the user, an input indicating the target electronic mail address or a recipient for the electronic mail message when the spoken input is received; and
sending the electronic mail message to the target electronic mail address.

2. The computer program product of claim 1, wherein the target electronic mail address is determined based on an identifier associated with a registered user of the computing device, the identifier being accessed from a user profile associated with the registered user.

3. The computer program product of claim 1, wherein the identifier associated with the registered user comprises an electronic mail address.

4. The computer program product of claim 1, wherein defining the electronic mail message comprises attaching an audio file or a link to the audio file to the communication, the audio file comprising at least a portion of the spoken input that was recorded in the recording mode.

5. (canceled)

6. The computer program product of claim 1, wherein the operations further comprise causing the transcript of the note to be added to a collection of notes managed by a note-taking application.

7. The computer program product of claim 6, further comprising causing a note category to be selected from among a plurality of note categories defined in the note-taking application based at least in part on a portion of the activation phrase, and wherein causing the transcript of the note to be added to the collection of notes comprises causing the transcript of the note to be added to a note canvas that corresponds to the selected note category.

8. The computer program product of claim 7, wherein one or more of the plurality of note categories is a user-defined note category.

9. The computer program product of claim 6, wherein the collection of notes is available only to a registered user of the computing device or someone using access credentials for the registered user.

10. A computer-implemented system, comprising:
a computing device having a microphone to receive spoken user input and to transmit the spoken user input for processing;
a speech-to-text converter module adapted to define a textual representation of the spoken user input;
an analyzer module adapted to (i) identify an activation phrase included in the spoken user input by analyzing the beginning of the spoken user input, wherein the activation phrase comprises one or more words that include the first word of the spoken user input, (ii) automatically activate a recording mode upon identifying that the activation phrase has been received, and (iii) initiate an automatic electronic mail messaging process, including determining a target electronic mail address, based at least in part on the identification of the activation phrase, wherein the activation phrase indicates an intent to record in the recording mode at least a portion of the spoken user input, wherein the target electronic mail address is determined without the user having specified the target electronic mail address or a message recipient in the spoken user input; and
a messaging module adapted to define an electronic mail message that includes at least a portion of the textual representation in a body of the electronic mail message,
wherein identifying the activation phrase and defining the electronic mail message are performed without user intervention.

11. The system of claim 10, wherein the speech-to-text converter module executes on a computer system that operates remotely from the computing device, and the spoken user input is transmitted to the computer system over a network.

12. (canceled)

13. The system of claim 10, wherein the messaging module excludes the activation phrase from the portion of the textual representation that is included in the body of the electronic mail message.

14. The system of claim 10, wherein the messaging module is further adapted to identify a registered user of the computing device by analyzing a user profile associated with the computing device.

15. The system of claim 14, wherein the target electronic mail address is determined based on information included in the user profile of the registered user of the computing device.

16. The system of claim 10, wherein the messaging module further defines the electronic mail message to include an audio file or a link to the audio file in the electronic mail message, the audio file comprising at least a portion of the spoken user input.

17. The system of claim 10, wherein the messaging module is further adapted to associate at least a first portion of the textual representation of the spoken user input with a note-managing application.

18. The system of claim 17, wherein the note-managing application is adapted to add the at least the first portion of the textual representation of the spoken user input to a collection of notes managed by the note-managing application.

19. The system of claim 18, wherein the note-managing application is further adapted to select a note category from among a plurality of note categories based at least in part on a portion of the activation phrase, and to add the at least the first portion of the textual representation of the spoken user input to a note canvas that corresponds to the selected note category.

20. (canceled)

21. A computer-implemented method comprising:
receiving, from a user of a computing device, a spoken input that includes a note and an activation phrase that indicates an intent to record the note;
determining that the activation phrase has been received by analyzing the beginning of the spoken input to identify one or more words as the activation phrase;
in response to determining that the activation phrase has been received, automatically:
activating a recording mode and recording the note in the recording mode
defining electronic mail message that is addressed to a target electronic mail address and that includes a machine-generated transcript of the note in a body of the electronic mail message, the target electronic mail address being determined without receiving, from the user, an input indicating the target electronic mail address or a recipient for the electronic mail message when the spoken input is received; and
sending the electronic mail message to the target electronic mail address.

22. The method of claim 21, wherein the target electronic mail address is determined based on an identifier associated with a registered user of the computing device, the identifier being accessed from a user profile associated with the registered user.

23. The method of claim 21, wherein the identifier associated with the registered user comprises an electronic mail address.

24. (canceled)

25. The method of claim 21, further comprising identifying a subject of the activation phrase and matching the identified subject to a first of a plurality of stored subjects, the first subject corresponding to note taking operations by the computing device when the subject of the activation phrase indicates the user's intent to record the note.

26. The method of claim 21, wherein defining the electronic mail message comprises:
creating a file that represents the spoken input of the activation phrase and the note;
transmitting the file to a server system, the server system (i) parsing the file to identify the activation phrase and to distinguish the activation phrase from the note and (ii) generating the transcript of the note; and
receiving, from the server system in response to the transmission of the file, the transcript of the note.

27. The computer program product of claim 1, wherein the operations further comprise identifying a subject of the activation phrase and matching the identified subject to a first of a plurality of stored subjects, the first subject corresponding to note taking operations by the computing device when the subject of the activation phrase indicates a user's intent to record the note.

28. The computer program product of claim 1, wherein defining the electronic mail message comprises:
creating a file that represents the spoken input of the activation phrase and the note;
transmitting the file to a server system for (i) parsing the file to identify the activation phrase and to distinguish the activation phrase from the note and (ii) generating the transcript of the note; and
receiving, from the server system in response to the transmission of the file, the transcript of the note.

29. The system of claim 10, wherein the analyzer module is further adapted to:
identify a subject of the activation phrase; and
match the identified subject to a first of a plurality of stored subjects, the first subject corresponding to note taking operations by the computing device when the subject of the activation phrase indicates a user's intent to record the note.

30. The system of claim 10, wherein the messaging module is further adapted to:
create a file that represents the spoken input of the activation phrase and the note;
transmit the file to a server system for (i) parsing the file to identify the activation phrase and to distinguish the activation phrase from the note and (ii) generating the transcript of the note; and
receive, from the server system in response to the transmission of the file, the transcript of the note.
